(19) United States
(12) Patent Application Publication
(10) Pub. No.: US 2017/0246940 A1
(43) Pub. Date: Aug. 31, 2017

(54) FRAMEWORK FOR CAR SUNSHADE AND CAR SUNSHADE

(71) Applicant: Meizhong WU, Yiwu, Zhejiang (CN)

(72) Inventor: Meizhong WU, Yiwu, Zhejiang (CN)

(21) Appl. No.: 15/511,163

(22) PCT Filed: Jun. 15, 2015
(86) PCT No.: PCT/CN2015/081446

§ 371 Date: Mar. 14, 2017

(30) Foreign Application Priority Data
Jun. 16, 2014 (CN) 201410267147.7

(51) Int. Cl. B60J 11/04

(52) U.S. Cl. CPC B60J 11/04

(57) ABSTRACT

A framework for a car sunshade and the car sunshade. The framework comprises a support frame (1) capable of being placed on a car roof. Four corners at the front, rear, left and right sides of the support frame (1) or two cornersAppl at the front part of the support frame (1) are provided with projecting positioning posts (2). Each positioning post (2) is provided with several ribs (3) that can rotate around the axial line of the positioning post (2) and fan out to form fan-like surfaces upon rotating toward the outer edge of the support frame (1). The ribs (3) are arranged on the positioning posts (2). When sunshade cloth (7) is arranged on the ribs (3), the ribs (3) rotate about the center line of the axial lines of the positioning posts (2) and fan out in a fan-like formation upon rotating toward the outer edge of the left and right sides of the support frame (1). Sunshading is realized by the formation of fan-like areas projecting outward from the support frame (1). Therefore, the overall structure is very simple, the manufacturing is convenient, and the production cost is low.

### TECHNICAL FIELD

The present invention relates to a car sunshading device, and particularly relates to a car sunshade framework and car sunshade.

### BACKGROUND

As the rate of car use increases, when parking under the hot sun, the metal panel of the car body may quickly accumulate heat, causing the temperature in the interior of the car to soar, and requiring the consumption of a large amount of energy to reduce the temperature after the car is driven. As a consequence, the use of car sunshades has become widely prevalent, and various types of sunshades have emerged to meet this need.

However, most early car sunshades required manual operation for opening and closing, which made use relatively inconvenient. Accordingly, the present applicant has designed a patent termed: “a car sunshade framework” (China patent number: 201010206352.4), which includes a base frame, where the top of the base frame is provided with a pair of transmission shafts disposed in parallel fashion in the front and rear, and the transmission shafts are provided with transmission shaft support elements; Both ends of each transmission shaft are provided with a shaft gear as a sleeve, where the shaft gears and transmission shaft support elements are attached, and each transmission shaft can revolve around the transmission shaft support elements and shaft gears; One gear connection element is attached to each end of each transmission shaft, and each gear connection element is provided with inserted lateral turning shafts that can rotate around the gear connection element. The lateral turning shafts pass through each gear connection element and connect with a revolving gear, where the revolving gear and shaft gear are meshing, and the lateral turning shafts are further provided with lateral turning rods; The top of the base frame is provided with a pair of driven shafts, and each driven shaft is provided with a side stop support rod. It is connected with an externally connected motor via front and rear transmission shafts, and rotates driven by the motor. As the transmission shaft rotates, it also causes the gear connection elements to turn in an outward direction; The lateral turning shafts rotate along with the gear connection elements, and open out toward the front and rear; the lateral turning shafts are connected with revolving gears, and the shaft gears and transmission shaft support elements are fixedly connected to the base frame; when the transmission shaft is in the process of rotation, the shaft gears and transmission shaft support elements are fixed and unmoving. Because the revolving gears and shaft gears are meshing, they rotate when the lateral turning shafts are turning in an outward direction, which causes the lateral turning rods on the lateral turning shafts to extend toward the left and right. The sunshade cloth retracts with the turning of the lateral turning rods and side stop support rods, and does not require manual operation; it easy to control automatically and very convenient to use. Accordingly, this design readily resolves the problem affecting early car sunshades of inconvenient use. However, the fact that the overall structure of this design is relatively complicated will cause its manufacture to be relatively inconvenient and its production cost to be high.

### SUMMARY

The present invention provides a car sunshade framework and car sunshade in which a plurality of ribs turn and extend to form a fan surface and realize sunshading; this resolves the prior art's technical problems of structural complexity, inconvenient production, and high production cost.

The present invention resolves the foregoing technical problems are resolved chiefly employing the following technical solutions: A car sunshade framework, which includes a support frame capable of being placed on a car roof. Four corners at the front, rear, left, and right sides of the support frame, or two corners at the front part of the support frame are provided with projecting positioning posts. Each positioning post is provided several ribs that can rotate around the axial line and fan out to form fan-like surfaces upon rotating toward the outer edge of the support frame. The ribs are arranged on the positioning posts. When sunshade cloth is arranged on the ribs, the ribs rotate about the center lines of the axial lines of the positioning posts, and fan out in a fan-like formation upon rotating toward the outer edge of the left and right sides of the support frame. Sunshading is realized by the formation of fan-like areas projecting outward from the support frame. The overall structure is consequently very simple, manufacturing is convenient, and production cost is low.

Preferably, the upper and lower layers of the foregoing ribs are arranged in an overlapping fashion, where the upper and lower ribs can rotate relative to each other to form an included angle, and the spaces between ribs are provided with a linkage mechanism used to drive the rotation of adjacent ribs. The linkage mechanism provided between the upper and lower ribs causes the ribs to effectively achieve extension and retraction, and it is only necessary to provide an overall source of motive power to effect the rotation of the uppermost ribs. Retraction is convenient, and is readily subject to automatic operation. The linkage mechanism may consist of small sections of cord or cloth strips, and may also be realized by providing pieces of cloth in the space made by the included angle after this included angle has been formed by the upper and lower ribs.

Preferably, the foregoing ribs are formed by rotating elements and support rods, where the foregoing linkage mechanism consists of pairs of connecting posts and connecting slots respectively disposed on the mating surfaces of adjacent rotating elements, the tops of the connecting posts extend into the connecting slots and can rotate within the connecting slots with the rotation of the rotating elements, and both ends of the connecting slots are provided with separating surfaces preventing the connecting posts from continuing to rotate in the connecting slots. The connecting posts and connecting slots are employed as a linkage mechanism, and the tops of the connecting posts extending into the connecting slots will rotate in the connecting slots with the rotation of the rotating elements. When extending, after the connecting posts within the connecting slots have rotated outward a certain angle, the separating surfaces of the outer ends of the connecting posts and connecting slots will be in contact, causing the upper and lower ribs to individually, jointly extend in rotating fashion, which enables the ribs to extend in a smooth and stable manner. Furthermore, when the ribs retract, after the connecting posts have rotated inward in the connecting slots a certain angle, the separating surfaces of the inner ends of the connecting posts and connecting slots will be in contact, causing the upper and lower ribs to individually, jointly retract in rotating fashion, enabling the ribs to retract quickly and effectively.

Preferably, the foregoing ribs include fixed ribs that are fixed relative to the support frame, two or more driven ribs located above the fixed ribs and set over the positioning posts in so that they are able to rotate, and driving ribs located above the driven ribs. The ribs consist of fixed ribs, driven ribs, and driving ribs, where the driving ribs rotate driven by an externally connected power source, and cause the driven ribs to rotate. Furthermore, since the fixed ribs are disposed so as to be fixed and unmoving relative to the support frame, the fixed ribs will not rotate with the rotation of the driven ribs above them, which causes the spaces between the ribs to form a stable fan-shaped sunshade surface after extension of the ribs. Furthermore, when retracting, the ribs can fully retract above the fixed ribs after the ribs have rotated in an inward direction. Retraction effectiveness will be good, it is only necessary to effect the rotation of the driving ribs to realize the extension of all the ribs, and the sunshade can readily be automatically operated.

Preferably, the positioning posts and support frame are conjoined, and the foregoing driving ribs are placed over the positioning posts so that they can rotate. When the positioning posts and support frame are fixed, the driving ribs can be freely placed on the positioning posts and thereby allow rotation about the positioning posts, achieving structural simplicity and convenient assembly.

Preferably, the positioning posts are disposed on the support frame so that they can rotate, and the foregoing driving ribs and positioning posts are conjoined. Of course, as an equivalent scheme, positioning posts can be disposed on the support frame so that they can rotate, and the driving ribs fixed on the positioning posts in order to realize rotation.

Preferably, the separating surfaces on the inner sides of the foregoing connecting posts and connecting slots are mutually corresponding. the front, upper sides of the separating surfaces on the inner sides of the connecting posts where they are situated in the connecting slots form a mutual correspondence with the separating surfaces, and the retracted volume will be small since the ribs can retract fully during retraction.

Preferably, the foregoing fixed ribs face toward the interior of the support frame or are disposed parallel to the right and left edges of the support frame, and the fan-like surface formed by the foregoing ribs when extended can have a maximum angle of 270°-360°. Because the foregoing fixed ribs face toward the interior of the support frame or are disposed parallel to the right and left edges of the support frame, the fixed ribs are located entirely within the support frame. When the ribs are extended, the inner side of the fan-like surface formed by the extension of the ribs is located within the support frame. The fan-like surface is thus able to form a better cover over both edges of the support frame, and provides better sunshading effectiveness. When the ribs retract, the ribs sequentially rotate and are retracted to above the fixed ribs; after retraction, the ribs are located within the support frame, and the volume is consequently small after retraction. The specific angular extent of the fan-like surface formed by the extension of the ribs can be determined by the included angle between the fixed ribs and the right and left edges of the support frame. When the fixed ribs are parallel to the right and left edges of the support frame, the fan-like surface formed by the full extension of the ribs will be set as 270°. When the included angle between the fixed ribs and the right and left edges of the support frame is 90°, the fan-like surface formed by the full extension of the ribs will be set as 360°. Accordingly, the maximum angle of 270°-360° of the fan-like surface formed by the extension of the ribs realizes full coverage to outside the edges and corners of the support frame when the ribs are extended, enabling excellent sunshading results.

Preferably, the difference between one-half of the distance between the left and right positioning posts on the foregoing support frame and the length of the ribs is 0-15 mm. During the process of extending the ribs, when the ribs on the right and left sides rotate until they are parallel with the front and rear edges of the support frame, a gap remains between the two facing ribs. Accordingly, there will be no collisions when the right and left ribs are extended, which will facilitate complete extension of the ribs. Furthermore, the length of this gap is set as less than than 30 mm, causing the gap created in the center of the front and rear sunshading areas to be small, and ensuring good sunshading effectiveness.

Preferably, the foregoing connecting slots are in a circular arc with the positioning posts at their center. The connecting slots are arranged in a circular arc the positioning posts at their center, and the shape of the connecting slots can mutually accommodate the path of motion of the connecting posts. Accordingly, the connecting posts and connecting slots will have a good fit, enabling smooth rotation.

Preferably, the foregoing support frame is provided with fixed, projecting limit posts serving to prevent the rotation of the driving ribs, and the limit posts are located on the inner side of the fixed ribs. When the driving ribs rotate and extend outward to the right and left from the interior of the support frame, they will rotate past the front and rear edges of the support frame to the interior of the support frame. The limit posts are disposed above the support frame and on the inner side of the fixed ribs; this ensures a good ability to limit and fix the driving ribs, and facilitates structural stability.

Preferably, the foregoing support rods and support frame have a parallel arrangement, facilitating the extension and retraction of the support rods.

A car sunshade, which includes sunshade cloth and a framework, where the framework is the car sunshade framework in any of the foregoing paragraphs. Because the foregoing framework has the aforementioned technical effects, a car sunshade with such a framework will have identical technical effects.

Preferably, the foregoing sunshade cloth consists of 4 pieces on the front, rear, right, and left, where the 4 pieces of sunshade cloth are fixed by the ribs disposed within the front, rear, right, and left quadrants of the support frame.

Preferably, the foregoing sunshade cloth consists of 2 pieces on the right and left, where the 2 pieces of sunshade cloth are fixed by the ribs disposed within the right and left sides of the support frame.

The present invention has the following characteristics in comparison with the prior art: The ribs are arranged on the positioning posts. When sunshade cloth is arranged on the ribs, the ribs rotate about the center lines of the axial lines of the positioning posts, and fan out in a fan-like formation upon rotating toward the outer edge of the left and right sides of the support frame. Sunshading is realized by the formation of fan-like areas projecting outward from the support frame. The overall structure is consequently very simple, manufacturing is convenient, and production cost is low. 2. The linkage mechanism provided between the upper and lower ribs causes the ribs to effectively achieve extension and retraction, and it is only necessary to provide an overall source of motive power to effect the rotation of the uppermost ribs. Retraction is convenient, and is readily subject to automatic operation. 3. the front, upper sides of the separating surfaces on the inner sides of the connecting posts where they are situated in the connecting slots form a mutual correspondence with the separating surfaces, and the retracted volume will be small since the ribs can retract fully during retraction.

### BRIEF DESCRIPTION OF THE DRAWINGS

Attached FIG. 1 is a structural schematic diagram of embodiment 1 of the present invention showing the car sunshade framework when extended.

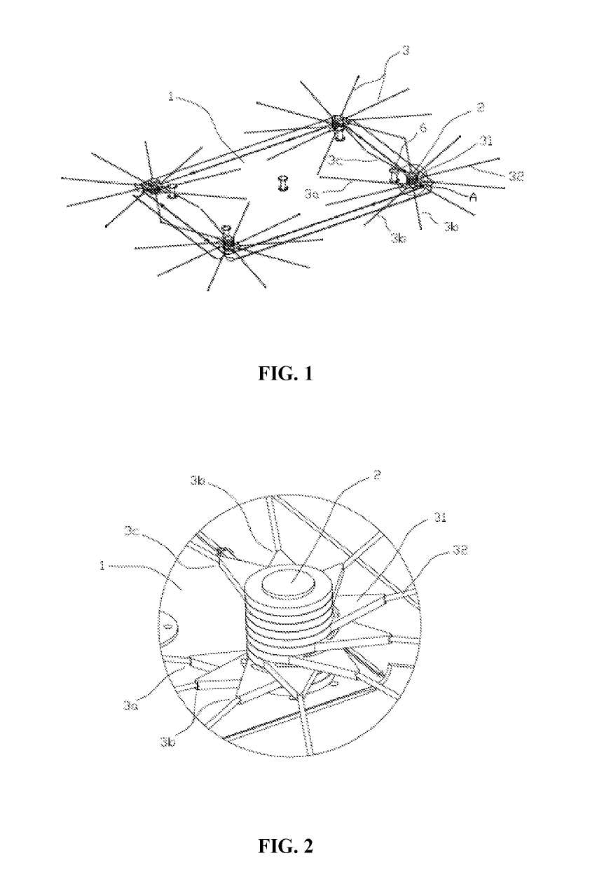

Attached FIG. 2 is an enlarged view of part A of attached FIG. 1.

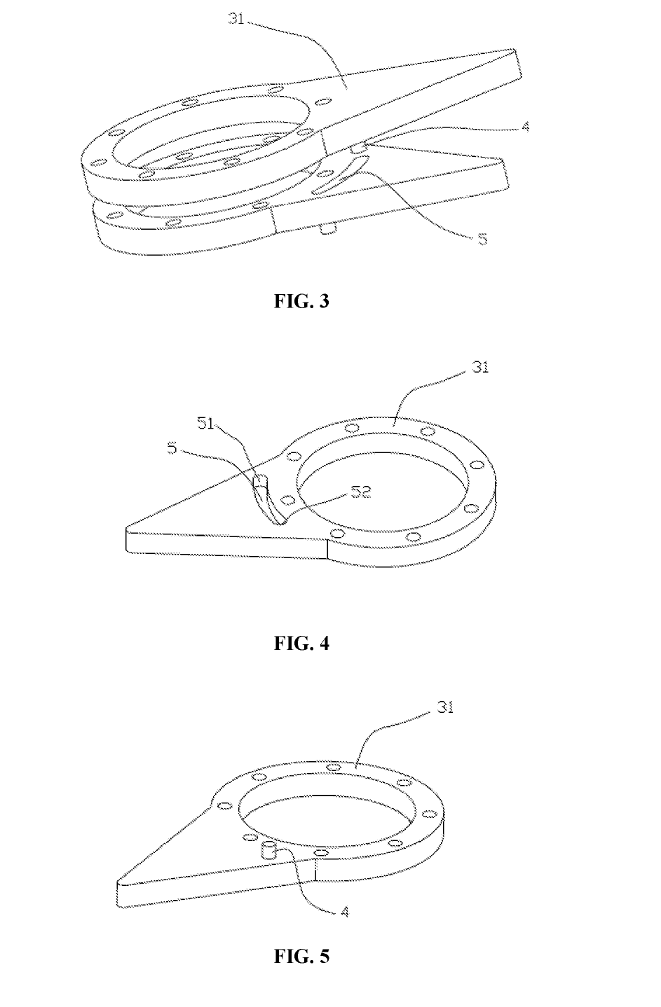

Attached FIG. 3 is a structural schematic diagram showing the mutual configuration of the rotating elements in embodiment 1 of the present invention.

Attached FIG. 4 is a structural schematic diagram showing a rotating elements in embodiment 1 of the present invention.

Attached FIG. 5 is a structural schematic diagram showing a rotating element in embodiment 1 of the present invention from another angle.

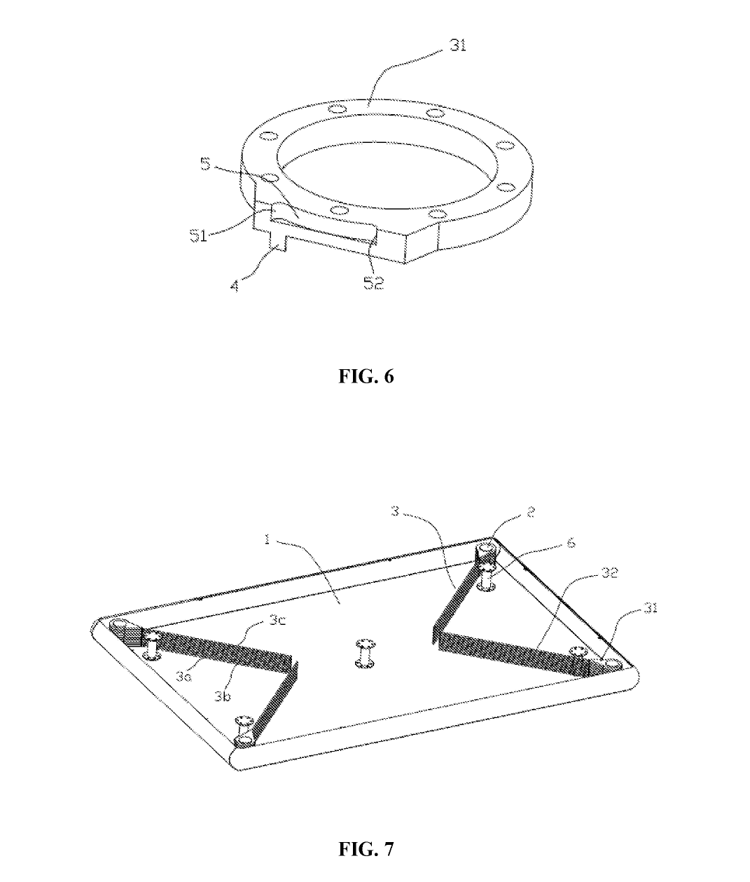

Attached FIG. 6 is a structural schematic diagram of a rotating elements in embodiment 1 showing the center line following the connecting post and the front cut-out portion of the connecting slot;

Attached FIG. 7 is a structural schematic diagram of the car sunshade framework in embodiment 1 of the present invention when in a retracted position.

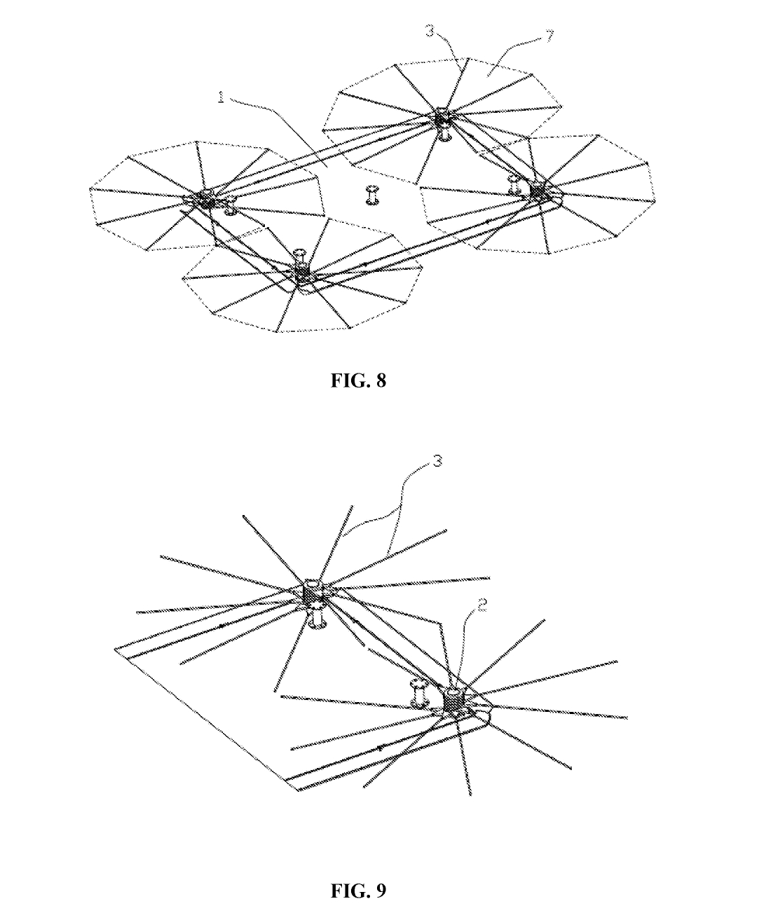

Attached FIG. 8 is a structural schematic diagram of the car sunshade in embodiment 1 of the present invention.

Attached FIG. 9 is a structural schematic diagram of the car sunshade framework in embodiment 1 of the present invention when in a retracted position.

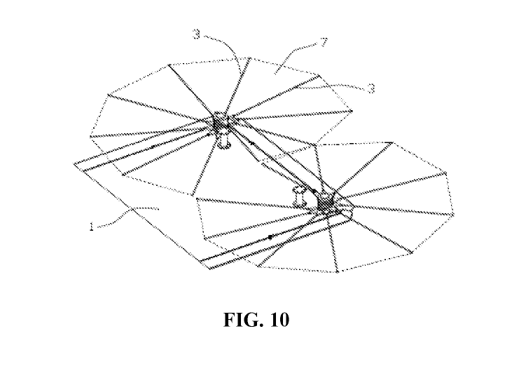

Attached FIG. 10 is a structural schematic diagram of the car sunshade in embodiment 2 of the present invention.

### DETAILED DESCRIPTION OF THE DRAWINGS

The following is a specific explanation of the present invention's technical solutions employing embodiments and referring to the attached figures.

Embodiment 1: See FIGS. 1 and 2; a car sunshade framework, which includes a support frame capable of being placed on a car roof 1, where support frame 1 is rectangular and can be mounted on the roof of an ordinary sedan. The four corners at the front, rear, left, and right sides of support frame 1 are provided with projecting positioning posts 2, and positioning posts 2 are arranged in a rectangle. Positioning posts 2 are 5 mm distant from the edge of support frame 1, and each positioning post 2 is provided several ribs 3 that can rotate around the axial line and fan out to form fan-like surfaces upon rotating toward the outer edge of the support frame 1. Ten ribs 3 are provided in the figure. Of course, the actual number of ribs is not restricted to ten, as long as they can extend to form a fan-like surface. The ribs are arranged on the positioning posts. When sunshade cloth is arranged on the ribs, the ribs rotate about the center lines of the axial lines of the positioning posts, and fan out in a fan-like formation upon rotating toward the outer edge of the left and right sides of the support frame. Sunshading of the two sides, front, and back of the car is realized by the formation of fan-like areas projecting outward from the support frame. The overall structure is consequently very simple, manufacturing is convenient, and production cost is low.

See FIGS. 1, 2, and 3; the upper and lower layers of the ribs 3 are arranged in an overlapping fashion, where the upper and lower ribs 3 can rotate relative to each other to form an included angle, and the spaces between ribs are provided with a linkage mechanism used to drive the rotation of adjacent ribs 3. The linkage mechanism provided between the upper and lower ribs causes the ribs to effectively achieve extension and retraction, and it is only necessary to provide an overall source of motive power to effect the rotation of the uppermost ribs. Retraction is convenient, and is readily subject to automatic operation. The linkage mechanism may consist of small sections of cord or cloth strips, and may also be realized by providing pieces of cloth in the space made by the included angle after this included angle has been formed by the upper and lower ribs.

See FIGS. 1, 3, and 6; the ribs 3 are formed by rotating elements 31 and support rods 32, where the foregoing linkage mechanism consists of pairs of connecting posts 4 and connecting slots 5 respectively disposed on the mating surfaces of adjacent rotating elements 31, the tops of the connecting posts 4 extend into the connecting slots 5 and can rotate within the connecting slots 5 with the rotation of the rotating elements 31, and both ends of the connecting slots 5 are provided with separating surfaces 51 and 52 preventing the connecting posts 4 from continuing to rotate in the connecting slots 5. The connecting posts and connecting slots are employed as a linkage mechanism, and the tops of the connecting posts extending into the connecting slots will rotate in the connecting slots with the rotation of the rotating elements. When extending, after the connecting posts within the connecting slots have rotated outward a certain angle, the separating surfaces of the outer ends of the connecting posts and connecting slots will be in contact, causing the upper and lower ribs to individually, jointly extend in rotating fashion, which enables the ribs to extend in a smooth and stable manner. Furthermore, when the ribs retract, after the connecting posts have rotated inward in the connecting slots a certain angle, the separating surfaces of the inner ends of the connecting posts and connecting slots will be in contact, causing the upper and lower ribs to individually, jointly retract in rotating fashion, enabling the ribs to retract quickly and effectively.

See FIGS. 1, 2, and 7; the ribs 3 include fixed ribs 3a that are fixed relative to the support frame 1, two or more driven ribs 3b located above the fixed ribs 3a and set over the positioning posts 2 in so that they are able to rotate, and driving ribs 3c located above the driven ribs 3b. The ribs consist of fixed ribs, driven ribs, and driving ribs, where the driving ribs rotate driven by an externally connected power source, and cause the driven ribs to rotate. Furthermore, since the fixed ribs are disposed so as to be fixed and unmoving relative to the support frame, the fixed ribs will not rotate with the rotation of the driven ribs above them, which causes the spaces between the ribs to form a stable fan-shaped sunshade surface after extension of the ribs. Furthermore, when retracting, the ribs can fully retract above the fixed ribs after the ribs have rotated in an inward direction. Retraction effectiveness will be good, it is only necessary to effect the rotation of the driving ribs to realize the extension of all the ribs, and the sunshade can readily be automatically operated.

See FIGS. 1, 2, and 7; the positioning posts 2 and support frame 1 are conjoined, and driving ribs 3c is placed on positioning post 2 so that it can rotate. When the positioning posts and support frame are fixed, the driving ribs can be freely placed on the positioning posts and thereby allow rotation about the positioning posts, achieving structural simplicity and convenient assembly. Of course, as an equivalent scheme, positioning posts 2 can be disposed on support frame 1 so that they can rotate, and driving ribs 3c and positioning posts 2 can be conjoined to realize rotation.

See FIG. 6; the separating surfaces of connecting post 4 and connecting slot 51 are mutually corresponding. Connecting post 4 is located to the front and above separating surface 51 in the connecting slot, allowing it to mate with separating surface 51. The side wall of connecting post 4 on the same side as separating surface 51 corresponds with separating surface 51 in the upward and downward directions. The retracted volume will be small since the ribs can retract fully during retraction.

See FIGS. 1 and 7; fixed ribs 3a face toward the interior of support frame 1, the included angle between fixed ribs 3a and the left and right edges of support frame 1 is 40°, the included angle between adjacent ribs 3 when extended is 35°, and the maximum angle of the fan-like surface formed by ribs 3 when extended is 315°. Accordingly, when driving ribs 3c rotate past the front and rear edges of support frame 1, they will rotate into the interior of support frame 1, and ribs 3 therefore completely cover the sides and corners of the support frame when extended, providing effective sunshading. Of course, fixed ribs 3a can be arranged parallel to the left and right edges of support frame 1. At that time, as long as the maximum angle of the fan-like surface formed by ribs 3 when extended is 270°, the fan-like surface can realize complete covering of the sides and corners of the support frame.

See FIG. 1; the difference between one-half the distance between right and left positioning posts 2 on support frame 1 and the length of ribs 3 is 3 mm. During the process of extending the ribs, when the ribs on the right and left sides rotate until they are parallel with the front and rear edges of the support frame, a gap remains between the two facing ribs. Accordingly, there will be no collisions when the right and left ribs are extended, which will facilitate complete extension of the ribs. Furthermore, the length of this gap is set as less than 30 mm, causing the gap created in the center of the front and rear sunshading areas to be small, and ensuring good sunshading effectiveness. By the same principle, the difference between one-half of the distance between the front and rear positioning posts 2 on support frame 1 and the length of the ribs 3 is 0-15 mm.

See FIG. 4; connecting slots 5 are arranged in a circular arc with positioning post 2 at their center. The connecting slots are arranged in a circular arc the positioning posts at their center, and the shape of the connecting slots can mutually accommodate the path of motion of the connecting posts. Accordingly, the connecting posts and connecting slots will have a good fit, enabling smooth rotation.

See FIGS. 1 and 7; support frame 1 is provided with fixed, projecting limit posts 6 serving to prevent the rotation of the driving ribs 3c, and the limit posts 6 are located on the inner side of the fixed ribs 3. When the driving ribs rotate and extend outward to the right and left from the interior of the support frame, they will rotate past the front and rear edges of the support frame to the interior of the support frame. The limit posts are disposed above the support frame and on the inner side of the fixed ribs; this ensures a good ability to limit and fix the driving ribs, and facilitates structural stability. See FIGS. 1 and 7; support rods 32 are in a parallel arrangement with support frame 1, facilitating the extension and retraction of the support rods.

FIG. 8 is a structural schematic diagram of an extended car sunshade comprising the car sunshade framework in this embodiment with sunshade cloth mounted on it. As shown in FIG. 8, sunshade cloth 7 consists of 4 pieces on the front, rear, right, and left; the 4 pieces of sunshade cloth 7 are respectively fixed by the ribs 3 disposed on the front, rear, right, and left portions of support frame 1, and form a fan-like surface when ribs 3 are fully extended. Sunshade cloth 7 covers the fan-like surface to form a fan-like sunshading surface, which possesses good sunshading effectiveness. When sunshade cloth 7 is fixed on the ribs, the ribs rotate about the center lines of the axial lines of the positioning posts, and fan out in a fan-like formation upon rotating toward the outer edge of the left and right sides of the support frame. Sunshading is realized by the formation of fan-like areas projecting outward from the support frame. The overall structure is consequently very simple, manufacturing is convenient, production cost is low, extension and retraction are convenient, and the sunshade is easy to operate automatically.

Embodiment 2: See FIG. 9; in the car sunshade framework, which includes a support frame capable of being placed on a car roof 1, support frame 1 is rectangular and can be mounted on the roof of an ordinary pickup or small van. The two front corners of support frame 1 are provided with projecting positioning posts 2, and positioning posts 2 are provided with several ribs 3 that can rotate around the axial line and fan out to form fan-like surfaces upon rotating toward the outer edge of the support frame 1; other aspects are identical with those in embodiment 1.

See FIG. 10, which shows a structural schematic diagram of an extended car sunshade comprising the car sunshade framework in this embodiment with sunshade cloth mounted on it. As shown in FIG. 8, sunshade cloth 7 consists of 2 pieces on the left and right; the 2 pieces of sunshade cloth 7 are respectively fixed by the ribs 3 disposed on the left and right portions of support frame 1, and form a fan-like surface when ribs 3 are fully extended. Sunshade cloth 7 covers the fan-like surface to form a fan-like sunshading surface, which possesses good sunshading effectiveness.

Various modifications of the present invention are obvious to any person skilled in this technical field; these modifications cannot be considered outside the scope of the present invention. All modifications obvious to any person skilled in this technical field are included within the scope of the current claims.

1. A car sunshade framework, which includes a support frame capable of being placed on a car roof, characterized by: Four corners at the front, rear, left, and right sides of the support frame, or two corners at the front part of the support frame are provided with projecting positioning posts. Each positioning post is provided several ribs that can rotate around the axial line and fan out to form fan-like surfaces upon rotating toward the outer edge of the support frame, the upper and lower layers of the foregoing ribs are arranged in an overlapping fashion, where the upper and lower ribs can rotate relative to each other to form an included angle, and the spaces between ribs are provided with a linkage mechanism used to drive the rotation of adjacent ribs(add).

2. (canceled)

3. The foregoing car sunshade framework in claim 1 is characterized by: The foregoing ribs are formed by rotating elements and support rods, where the foregoing linkage mechanism consists of pairs of connecting posts and connecting slots respectively disposed on the mating surfaces of adjacent rotating elements, the tops of the connecting posts extend into the connecting slots and can rotate within the connecting slots with the rotation of the rotating elements, and both ends of the connecting slots are provided with separating surfaces preventing the connecting posts from continuing to rotate in the connecting slots.

4. The foregoing car sunshade framework in claim 1 is characterized by: The foregoing ribs include fixed ribs that are fixed relative to the support frame, two or more driven ribs located above the fixed ribs and set over the positioning posts in so that they are able to rotate, and driving ribs located above the driven ribs.

5. The foregoing car sunshade framework in claim 4 is characterized by: The positioning posts and support frame are conjoined, and the foregoing driving ribs are placed over the positioning posts so that they can rotate.

6. The foregoing car sunshade framework in claim 4 is characterized by: The positioning posts are disposed on the support frame so that they can rotate, and the foregoing driving ribs and positioning posts are conjoined.

7. The foregoing car sunshade framework in claim 3 is characterized by: The separating surfaces on the foregoing connecting posts and connecting slots are mutually corresponding.

8. The foregoing car sunshade framework in claim 4 is characterized by: The foregoing fixed ribs face toward the interior of the support frame or are disposed parallel to the right and left edges of the support frame, and the fan-like surface formed by the driving ribs, the driven ribs and the fixed ribs when extended can have a maximum angle of 270°-360°.

9. The foregoing car sunshade framework in claim 8 is characterized by: The difference between one-half of the distance between the left and right positioning posts on the foregoing support frame and the length of the driving ribs or the driven ribs is 0-15 mm.

10. The foregoing car sunshade framework in claim 3 is characterized by: The foregoing connecting slots are in a circular arc with the positioning posts at their center.

11. The foregoing car sunshade framework in claim 4 is characterized by: The foregoing support frame is provided with fixed, projecting limit posts serving to prevent the rotation of the driving ribs, and the limit posts are located on the inner side of the fixed ribs.

12. The foregoing car sunshade framework in claim 3 is characterized by: The foregoing support rods and support frame have a parallel arrangement.

13. A car sunshade, including sunshade cloth and a framework, is characterized by: The framework consists of the car sunshade framework in claim 12.

14. The foregoing car sunshade framework in claim 13 is characterized by: The foregoing sunshade cloth consists of 4 pieces on the front, rear, right, and left, where the 4 pieces of sunshade cloth are fixed by the ribs disposed within the front, rear, right, and left quadrants of the support frame.

15. The foregoing car sunshade framework in claim 13 is characterized by: The foregoing sunshade cloth consists of 2 pieces on the right and left, where the 2 pieces of sunshade cloth are fixed by the ribs disposed within the right and left sides of the support frame.
